(19) United States
(12) Patent Application Publication
(10) Pub. No.: US 2016/0100661 A1
(43) Pub. Date: Apr. 14, 2016

(54) Compartments for Tool Bags

(71) Applicants: Andrzej Michal Redzisz, Wheeling, IL (US); Ye Zhang, HangZhou (CN)

(72) Inventors: Andrzej Michal Redzisz, Wheeling, IL (US); Ye Zhang, HangZhou (CN)

(73) Assignee: Impak Luggage LLC, Pine Brooks, NJ (US)

(21) Appl. No.: 14/736,086

(22) Filed: Jun. 10, 2015

(30) Foreign Application Priority Data
Jul. 18, 2014 (CN) CN201420399399

(51) Int. Cl. A45C 13/02; B62B 1/26; B25H 3/00; A45C 13/26; A45C 13/10

(52) U.S. Cl. CPC A45C 13/02; A45C 13/262; A45C 13/103; B25H 3/00; B62B 1/26

(57) ABSTRACT

A tool bag for storing and organizing tools is provided. In general, the described tool bag includes a flat bottom surface connected to at least one side components, wherein the flat bottom surface includes a hard flat surface. The tool bag also includes a mid-section including a hard surfaced compartment with two surfaces, where the hard surfaced compartment is positioned perpendicular to the flat bottom surface and divides the tool bag's internal bag space into two substantially equal portions. Furthermore, a plurality of tool organizing apparatuses is affixed to the two surfaces of the hard surfaced compartment configured to secure and organize tools.

### FIELD

The present invention relates to tool storage apparatuses, and in particular, to compartment components for tool bags for easy organizing, transporting and accessing tools.

### BACKGROUND

Various types of tool carrying apparatus are currently available on the market designed to store and transport tools. In certain cases, some of the tool carrying apparatuses are rigid tool boxes that have a hinged top and a removable tray that lifts out for accessing a lower interior area designed for bulk tool storage. Other, similar tool boxes may include small drawers for storing smaller tools or parts. However, these types of tool boxes are usually designed to store tools horizontally, often resulting in a disorganized mass of tools in a single storage area in the bottom of the tool box. This arrangement can make selection and accessing of stored tools somewhat difficult and potentially dangerous.

Another disadvantage of rigid tool boxes is that often they do not conform to storage areas provided in vehicles. Usually tradesmen transport or store tool boxes in their vehicles, however, enough space for a rectangular hard tool box is often not available.

Other tool storage apparatuses can be, for example, fabric bags similar to doctor's bags having a zippered opening providing access to an inside cavity for storing tools. However, tools stored in this type of bag are also generally stored together, horizontally, in a single storage area. Inner pockets may be provided, although access to the inner pockets can be substantially restricted when the bag is full or partially full of tools.

Fabric tool bags can be an alternative to the rigid tool boxes, but the fabric bags do not overcome the problems associated with the bulk tool storage. Also, when storing or transporting sharp tools horizontally or in pockets, in a purely fabric bag, the bag can easily be damaged by the tools.

Another tool storage apparatus can be a bag designed to fit over an empty 5-gallon plastic bucket. This type of bag often has a variety of tool pockets designed to fit both on the inside and outside of the bucket. The bucket provides a frame and supports the tool bag. One disadvantage of this type of tool bag is that convenient storage space for a 5-gallon bucket is often quite limited in vehicles, making it difficult to transport the stored tools.

Accordingly, there is a need for improved tool storage components to store and organize tools.

### SUMMARY

Tool bags for storing and organizing tools are provided. A tool bag can include a flat bottom surface connected to at least one side components, wherein the flat bottom surface includes a hard flat surface. The tool bag can further include a mid-section including a hard surfaced compartment with two surfaces, where the hard surfaced compartment is positioned perpendicular to the flat bottom surface and divides the tool bag's internal bag space into two substantially equal portions. A plurality of tool organizing apparatuses can also be affixed to the two surfaces of the hard surfaced compartment configured to secure and organize tools.

### BRIEF DESCRIPTION OF THE DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a schematic illustration of a tool bag with a mid-section for storing tools (not shown);

FIG. 2 is a schematic illustration of a tool bag in a opened position with a mid-section for storing tools;

FIG. 3 is a schematic illustration of a mid-section for storing tools;

FIG. 4 is a schematic illustration of another mid-section for storing tools;

FIG. 5 is a schematic illustration of a tool bag in a opened position with a mid-section for storing tools;

FIG. 6 is a schematic illustration of a tool bag in a semi-opened position with a mid-section for storing tools;

FIG. 7 is another schematic illustration of another tool bag in a semi-opened position with a mid-section for storing tools;

FIG. 8 is yet another schematic illustration of another tool bag in a semi-opened position with a mid-section for storing tools;

FIG. 9 is a schematic illustration of one embodiment of a tool bag with a mid-section for storing tools;

FIG. 10 is a schematic illustration of a tool bag with a handle and wheels for easy pulling and a mid-section (not shown) for storing tools;

FIG. 11 is a schematic illustration of a tool bag on wheels in a semi-opened position with a mid-section for storing tools;

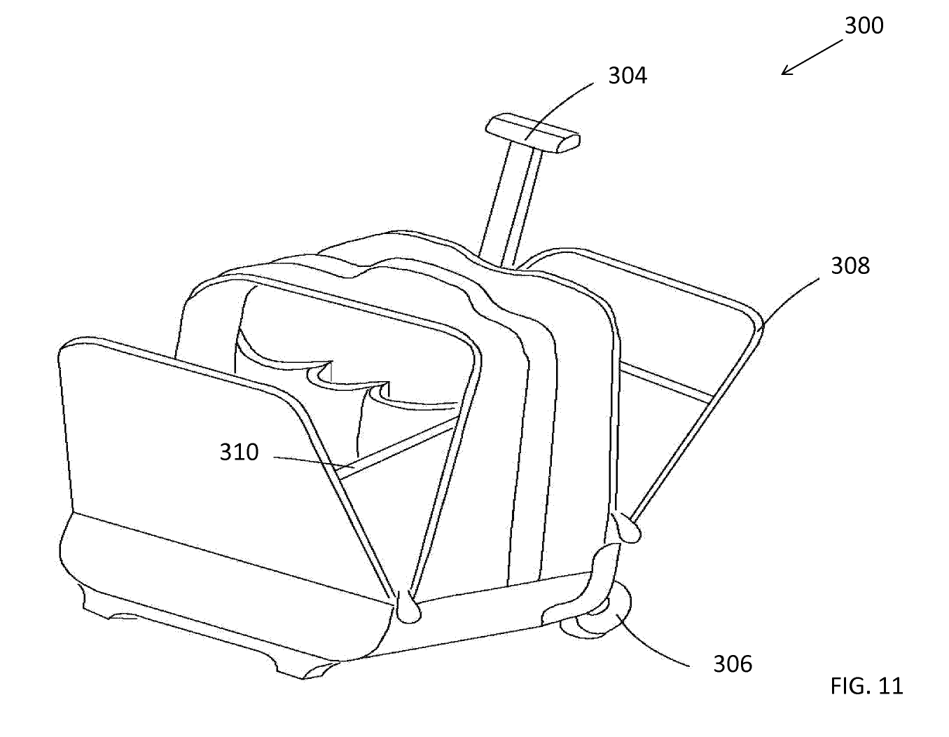

FIG. 12 is one embodiment of a tool bag with a mid-section (not shown) for storing tools;

FIG. 13 is a side view of the tool bag illustrated in FIG. 12;

FIG. 14 is an illustration of the tool bag shown in FIG. 12 in a semi-opened position with a mid-section for storing tools;

FIG. 15 is an illustration of a tool bag in a semi-opened position with amid-section for storing tools;

FIG. 16 illustrates another embodiment of a tool bag with a mid-section (not shown) for storing tools;

FIG. 17 is a side view of the tool bag illustrated in FIG. 16;

FIG. 18 illustrates yet another embodiment of a tool bag with a mid-section (not shown) for storing tools; and

FIG. 19 is a side view of the tool bag illustrated in FIG. 18.

### DETAILED DESCRIPTION

Certain exemplary embodiments will now be described to provide an overall understanding of the principles of the systems and methods disclosed herein. One or more examples of these embodiments are illustrated in the accompanying drawings. Those skilled in the art will understand that the systems, apparatuses and methods specifically described herein and illustrated in the accompanying drawings are non-limiting exemplary embodiments and that the scope of the embodiments is defined solely by the claims. Further, the features illustrated or described in connection with one exemplary embodiment may be combined with the features of other embodiments. Such modifications and variations are intended to be included within the scope of the described embodiments.

The embodiments described herein generally relate to tool bags and compartment components for tool bags.

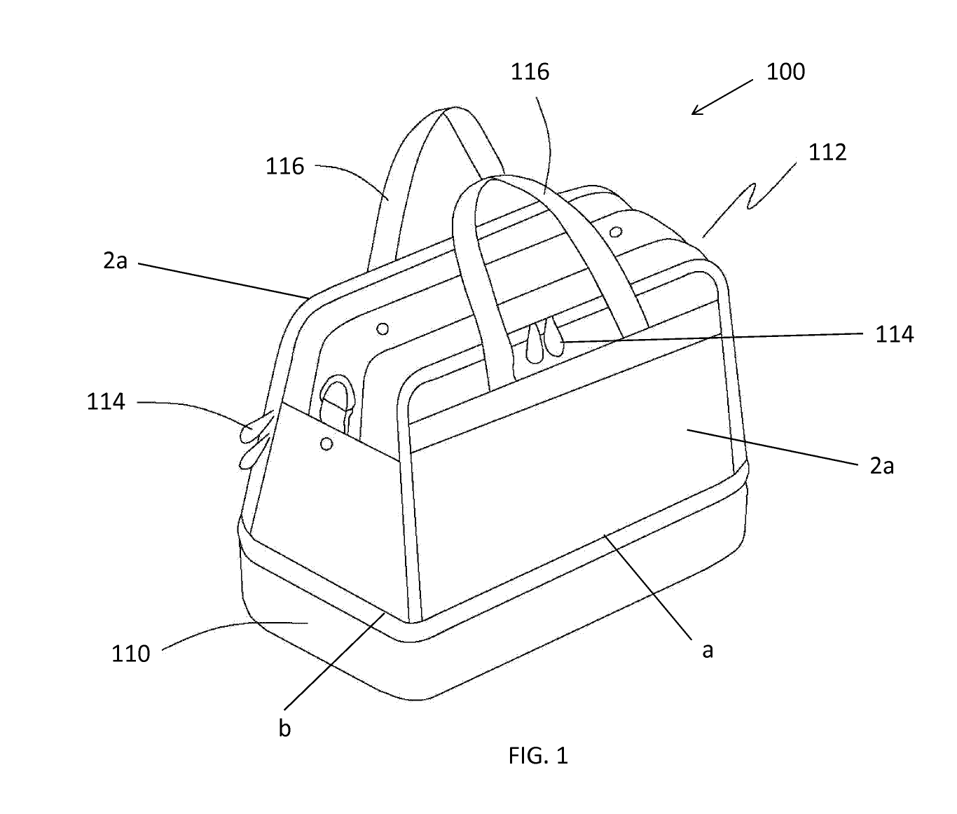

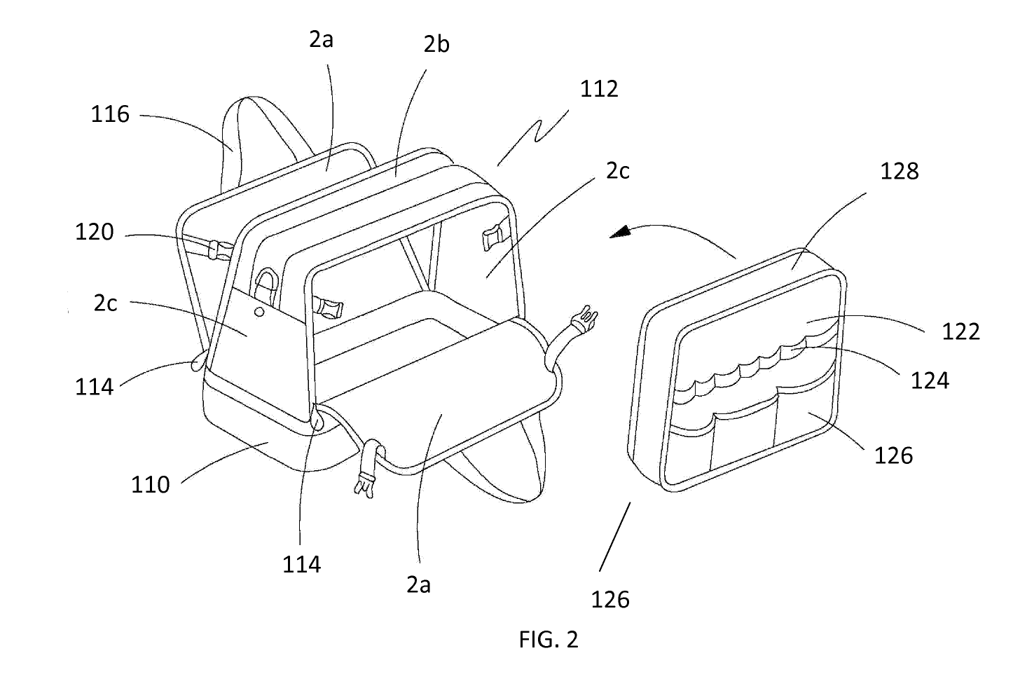

FIG. 1 illustrates an exemplary tool storage apparatus in accordance with the subject matters described herein. In some embodiments, the tool storage apparatus can be a tool bag 100 configured to store and organize multiple tools. As shown in FIG. 1, the tool bag 100 can include a base portion 110 with a substantially flat bottom surface. The base portion 110 can include four vertical sides arranged in a standing up fashion and connected to a body portion 112. The body portion 112 can be substantially rectangular in shape and be constructed of materials such as fabrics. In some embodiments the body portion 112 can include two longer sides a and two shorter sides b, where the longer sides can include one or more front covers 2a configured to provide easy access to the tool bag 100. In use, as illustrated in more details in FIG. 2 below, front covers 2a can be opened by pulling on one or more zippers 114 and an user can access tools stored inside the tool bag 112. The zippers 114 can be configured to be shaped in a “doorway” like fashion and pulled down to the base portion 110. In this way, as illustrated in FIG. 2, the front covers 2a can open up partially and allow access to the tools. In some embodiments, the tool bag 112 can further include two side covers 2c configured to support the overall structure of the bag 112. Furthermore, the tool bag 112 can include two U shaped handles 116 attached to the front covers 2a. In use, an user can grab onto the handles 116 and carry the entire tool bag 112 by the handles 116.

In use, the tool bag 112 can further include a mid-section 118 position positioned between the side covers 2c and parallel to the front covers 2a. The mid-section 118 can be generally rectangular in shape with tool organizing features on both sides. For example, as illustrated in FIG. 2, each side of the mid-section 118 (the side that's facing the front cover 2a for example) can have multiple tool organizing features. As shown in FIG. 2, the mid-section 118 can have a separation plate 122 and tool organizing features such as stationary bands 124 and discrete tool compartments 126 can be affixed to the separation plate 122. In some embodiments, the stationary band 124 can be elastic in nature and in use, tools such as screw drivers with long necks can be positioned within a tool compartment 126 with one end inserted between the stationary band 124 and the separation plate 122 and firmed secured within the tool bag. The configuration advantageously provides an user with the ability to store and organize multiple tools of various sizes and configuration within the tool bag 112 in a secured fashion. In some embodiments, the mid-section 118 can be inserted and then secured within the tool bag 112 by, for example, stapling a top surface 128 of the mid-section 118 to a top surface 2b of the tool bag 112. In other embodiments, the top surface 128 of the mid-section 118 may be glued or attached to the top surface 2b of the tool bag through other means common used within the art (e.g., using Velcro etc.) Not only does the mid-section 118 provides extra means of organizing tools in the tool bag 118, but the rigid nature of the mid-section 118 can also contributes to a better overall structure strengthening of the tool bag. For example, by being positioned in between the top surface 2b and base portion 110, the mid-section 118 is able to provide extra support to the tool bag 112 in the vertical direction. In yet another embodiment, the mid-section 118 can be designed to be replaceable in reference to the tool bag 112. That is, the mid-section 118 can be removed and replaced with another mid-section into the tool bag 112. The replacement mid-section may be of similar dimension to the replaced mid-section 118, but can include different tool organizing features, as discussed in more details below. In use, in addition to being held open or closed by one or more zippers 114 as illustrated in FIG. 1, one or more buckles 120 can be utilized to keep the front covers 2a in a semi-opened position. The buckle 120 can be similar to the ones present in luggage cases used for securing personal luggage. It should be appreciated that other similar devices commonly used within the art can be easily adopted to keep the front covers 2a open or closed.

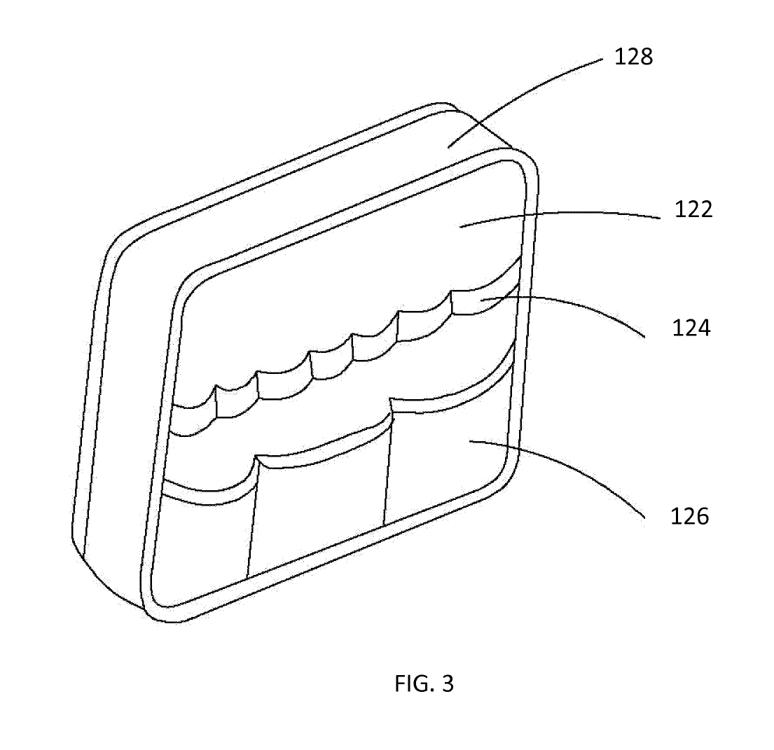

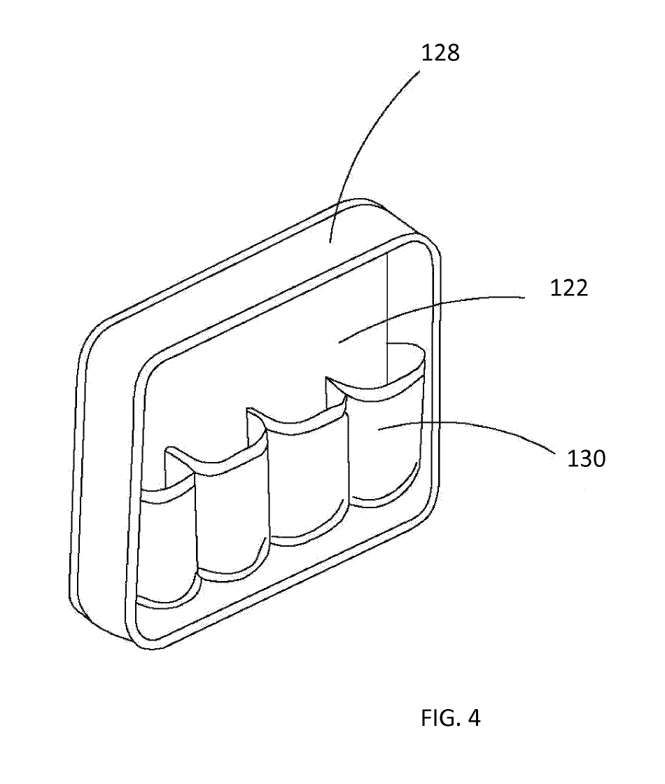

FIGS. 3 and 4 are exemplary tool organizing features that can be attached to the separation plate 122 of the mid-section 118. As discussed above and illustrated in FIG. 3, one side of the separation plate 122 can include a plurality of stationary bands 124 and tool compartments 126. Tools can be positioned and secured by the stationary bands 124 and within the tool compartments. Similarly, as illustrated in FIG. 4, another side of the separation plate 122 can include a plurality of tool containers 130. The tool containers 130 can be larger in size compared to the tool compartments 126, and the tool containers can be configured to hold various tools and gadgets such as nuts and bolts.

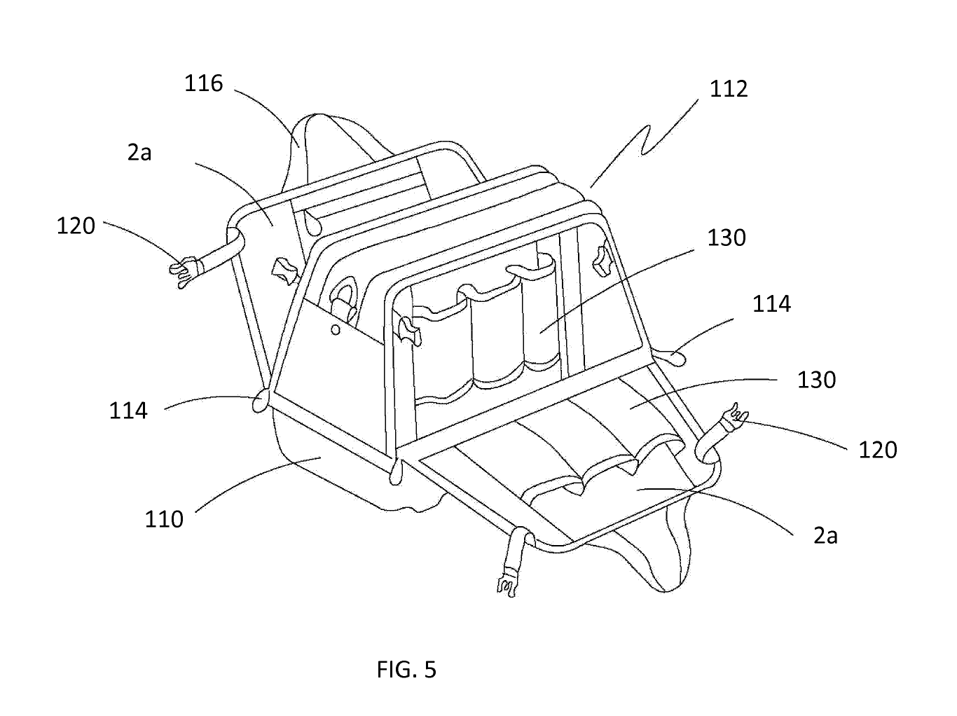

FIG. 5 illustrates the tool bag 112 in a fully opened position. When fully opened, the buckle 120 is detached from one another and the zippers 114 all sled all the way down to the side, fully exposing the mid-section 118 and the tool containers 130 affixed to the separation plate 122. In addition, in some embodiments, a plurality of tool containers 130 can be positioned on the front cover 2a, providing even more spaces for organizing tools.

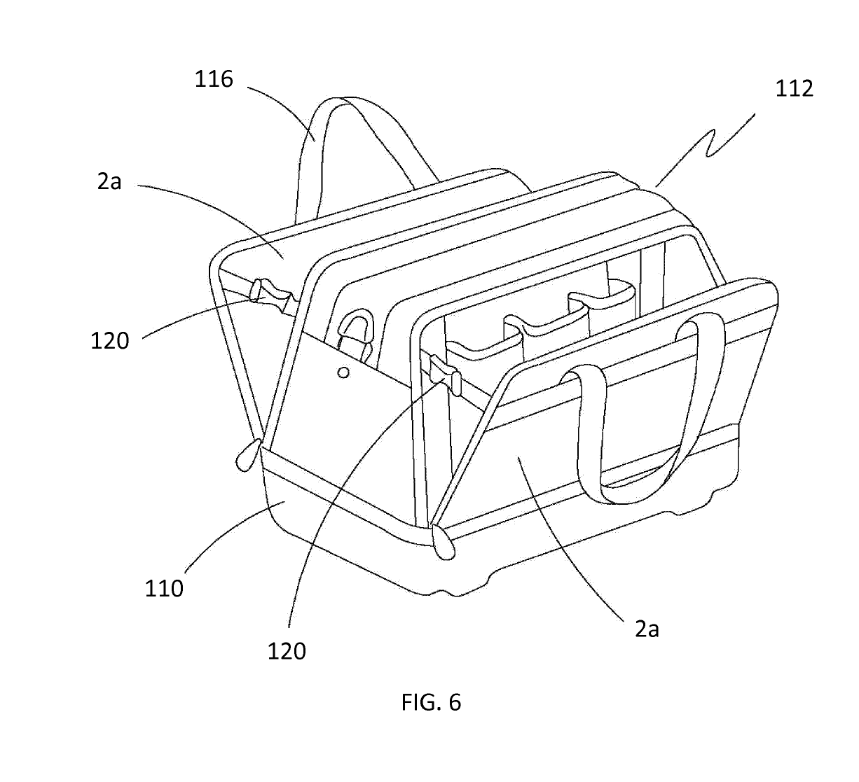

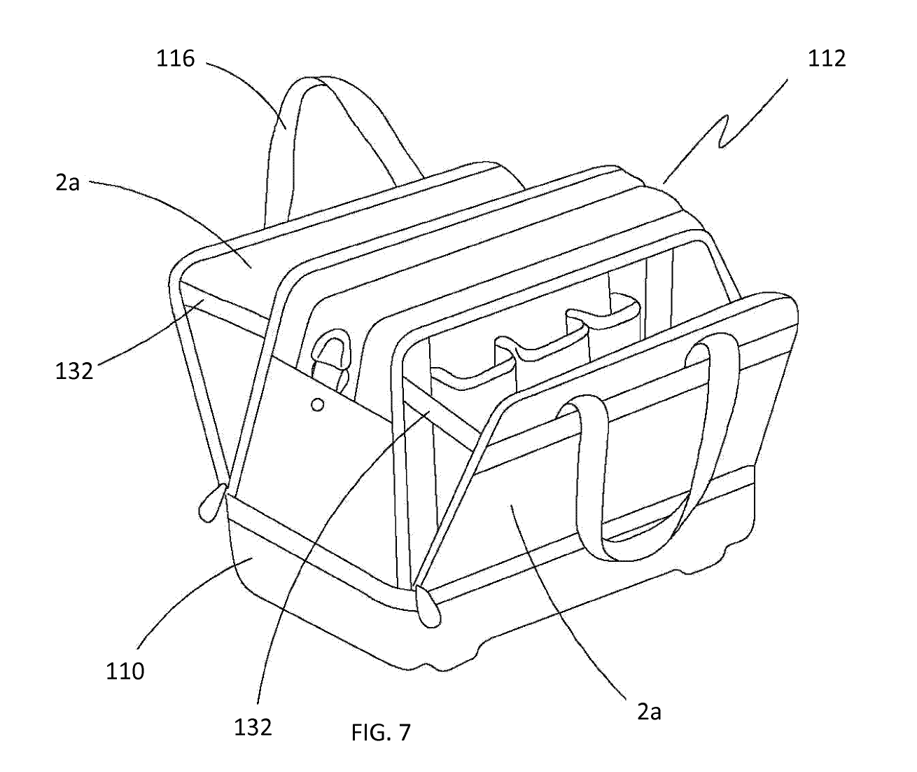

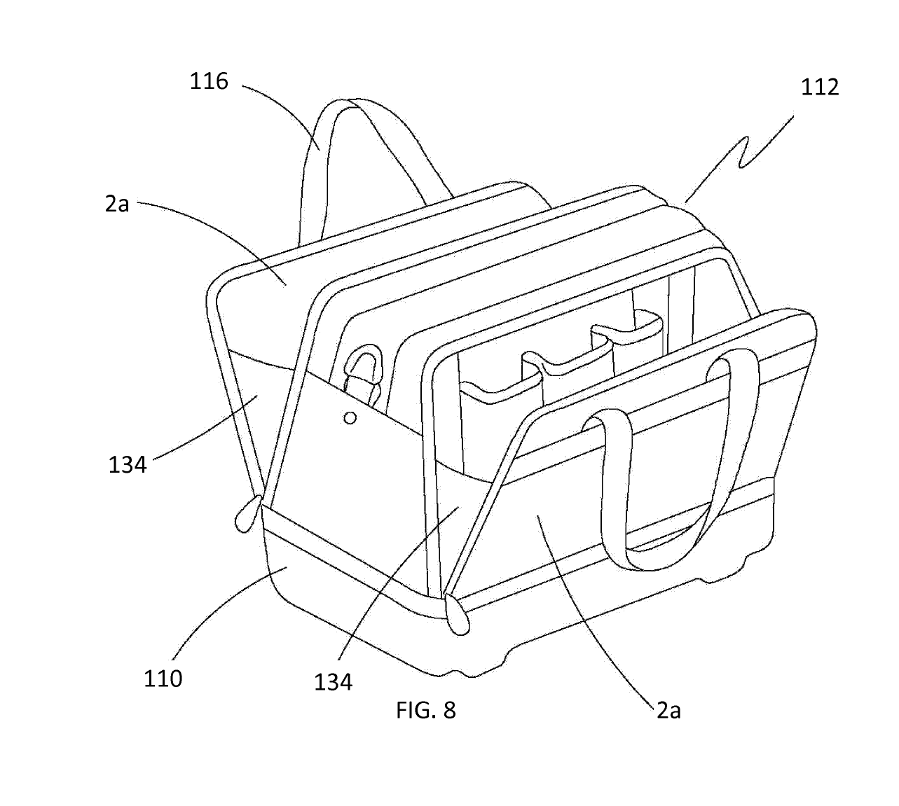

In use, the tool bag 112 is capable of maintaining a half-opened position, allowing access to the tools stored inside the bag while keeping the tools secured within the tool bag 112. FIGS. 6-8 illustrate various methods to maintain a half-opened position. In one embodiment, as illustrated in FIG. 6, one or more buckles 120 can be used to connected the front cover 2a and the tool bag 112. The buckle 120 can have certain length such that when the buckle 120 is in a connected position, the front cover 2a opens half way from the tool bag 112. Allowing access to the tools stored on the mid-section and the front cover 2a (not shown). Similarly, an elastic material such as an elastic band can be used to connect the front cover and the tool bag. As illustrated in FIG. 7, the front cover 2a can be connected to the tool bag 112 via one or more elastic band 132. The elastic bands 132 are of certain length such that when fully extended, the bands 132 keep the front cover 2a at a half-opened position in reference to the tool bag 112. In another embodiment, a piece of fabric 134, as illustrated in FIG. 8, can be used to keep the front covers 2a at a half-opened position. It should be appreciated that the embodiments illustrated here are for exemplary purposes and other similar devices can be easily adopted by one skilled in the art to keep the front cover 2a in a half opened position.

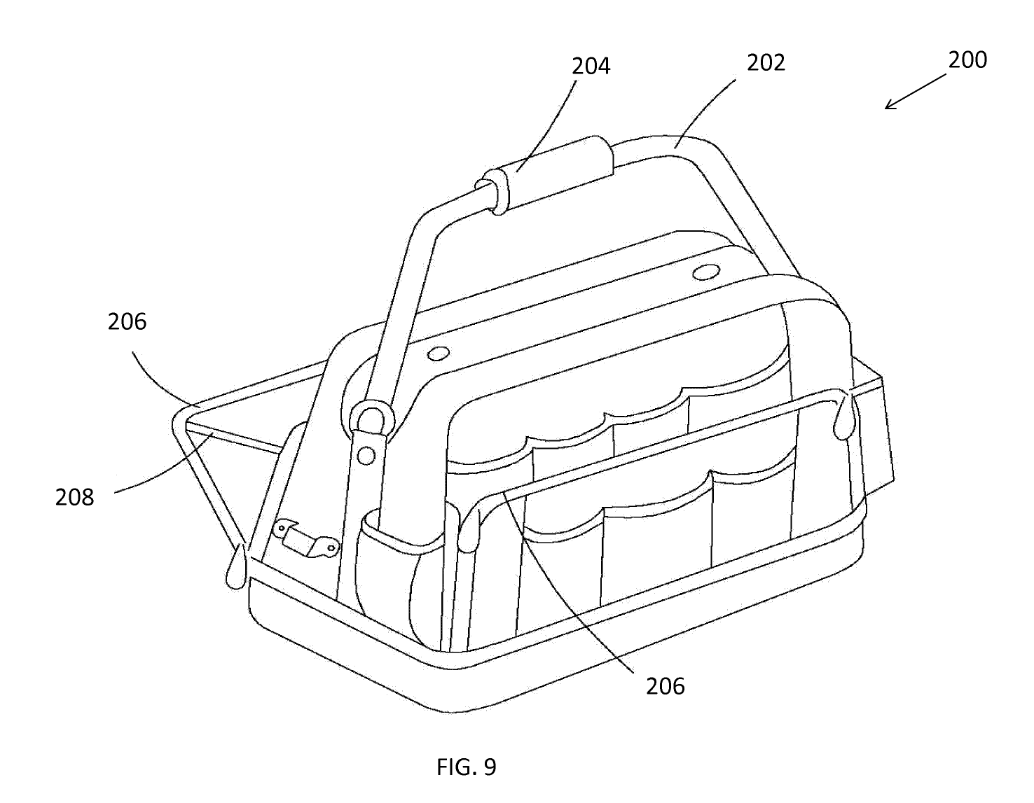

FIG. 9 illustrates another embodiment of the present subject matter. As illustrated in FIG. 9, instead of U shaped handles, a tool bag 200 can have a solid handle bar 202 with a handle 204. The handle bar can be made out of harden material such as metal or hard plastic and the entire bag can be carried on the handle 204. In some embodiments, the handle 204 can include material configured to prevent slippage and also provide cushion. In addition to the tool organizing features present on the mid-section, the front covers 206 can have tool containers build in. One or more elastic bands 208 can be used to connect the front covers 206 to the tool bag 200. When fully extended, the elastic bands 208 can keep the front covers at a semi-opened position. It should be noted that other devices such as buckles, fabrics and strings can be easily adopted to achieve a similar purpose.

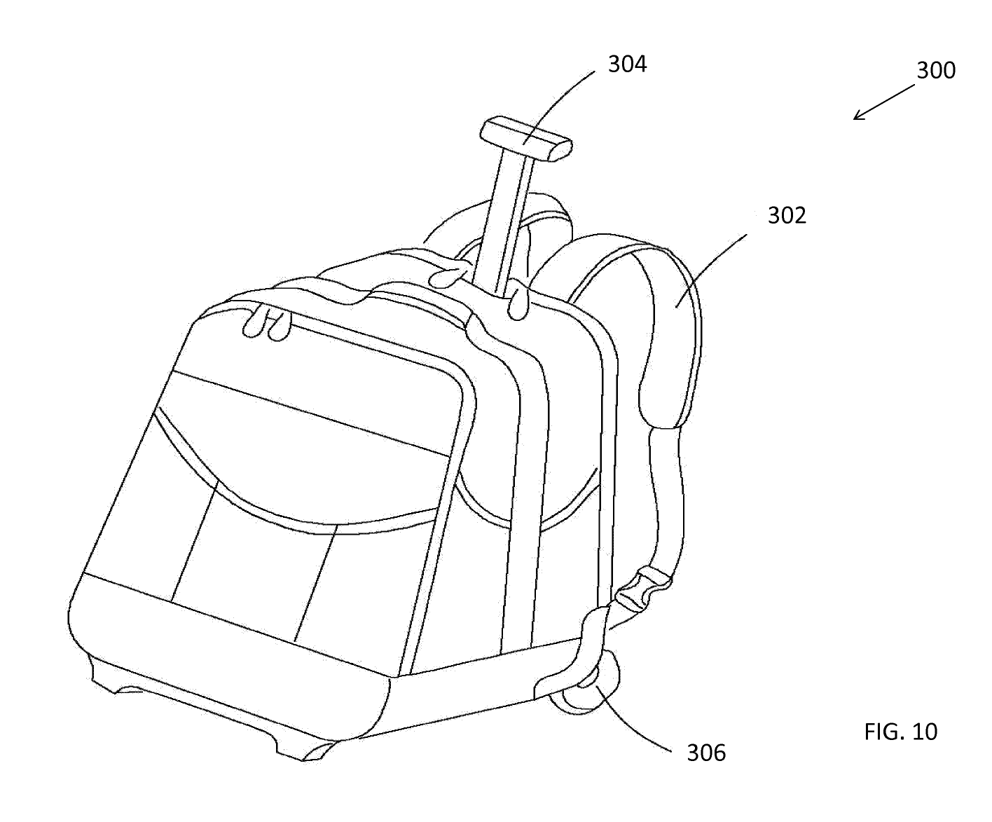

In some embodiments, additional features can be integrated into a tool bag to further enhance the ease of operating a tool bag similar to the ones described above (in FIGS. 1-9). For example, a tool bag 300 can be fitted with a shoulder pad 302 for an easy carrying on one's back. In addition, the tool bag 300 can also be fitted with rolling wheels 302 and a pull handle 304 as illustrated in FIG. 10 for easy pulling on the ground. Similar to the tool bag discussed above, tool bag 300 can include one or more front covers 308 connected to the bag by one or more strings 310. When fully extended, the strings 310 can keep the front covers 308 at a semi-opened fashion

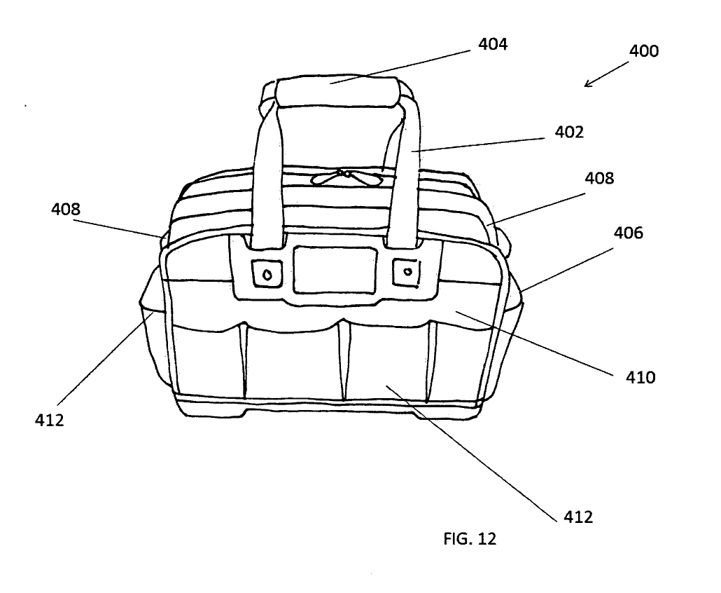

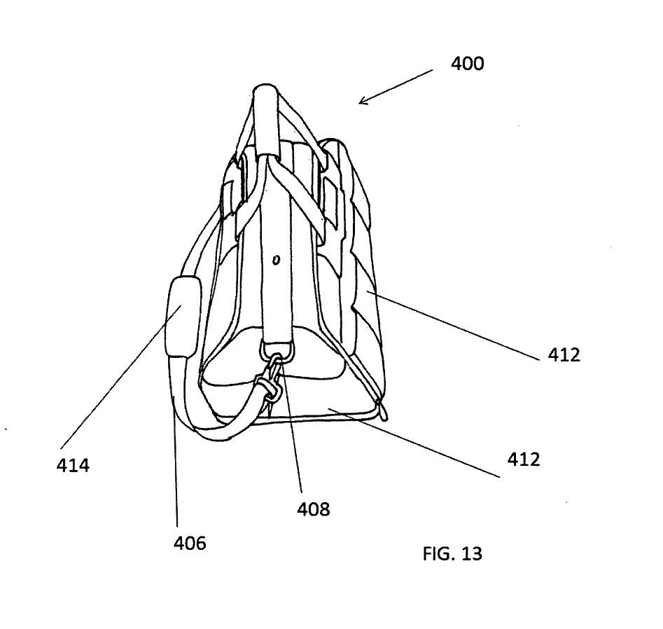

In another embodiment, a tool bag 400 similar to the one described in FIG. 1 can have one or more U shaped handle 402 coupled to an anti-slippage and/or cushion handle 404 as illustrated in FIG. 12. The tool bag 400 can also have shoulder strap 406 connected to two rings 408 affixed to the bag's surface, where the shoulder strap 406 enables an user to carry the tool bag 400 on his/her shoulders. Similar to the tool bag described in FIG. 1, tool bag 400 can also have one or more front covers 410 configured to provide closure to the tools stored within the bag 400. Furthermore, a plurality of tool containers 412 of various dimensions can be affixed to the front cover 410, as well as to the side of the tool bag 400. FIG. 13 is a side view of the tool bag 400 described in FIG. 12. As illustrated in FIG. 13, the tool bag 400 can have one or more rings 408 configured to be coupled to a shoulder strap 406. The shoulder strap 406 can further include an anti-slippage and/or cushion 414 designed to provide comfort when a user is carrying the tool bag 400 on his/her shoulders.

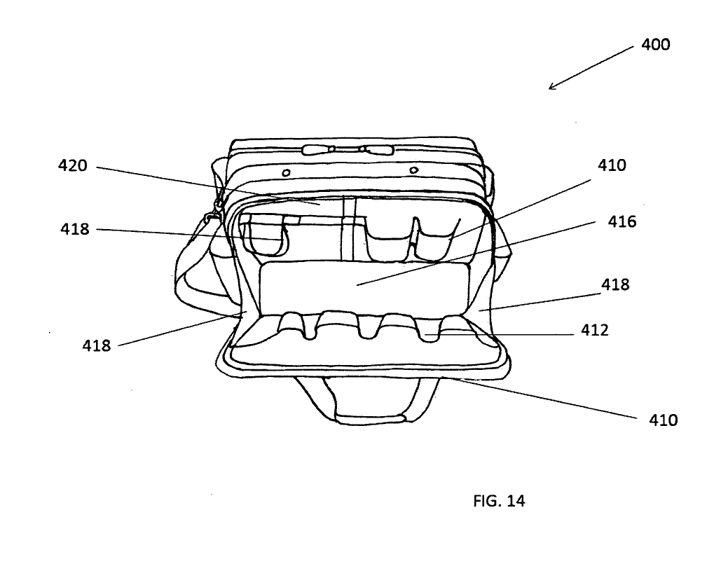

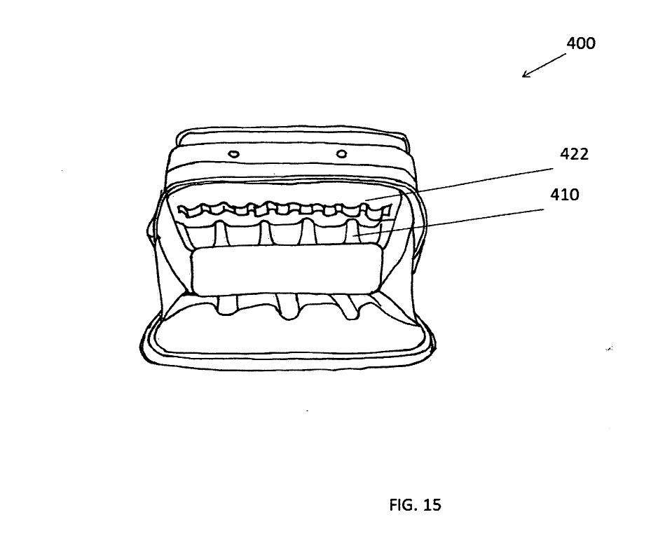

In use, the tool bag 400 can be configured to remain semi-open for an easy access to the tool inside, as illustrated in FIG. 14. The front cover 410 can be kept open by one or more fabrics 418 connecting the front cover 410 to the bag. The front cover 410 can have a plurality of tool containers attached to the front cover's 412 inner surface facing the tool bag 400 and configured to store tools of various dimensions. Once the front cover 410 is opened, a user can have access to the tools stored on the mid-section 420 of the bag. As illustrated in FIG. 14, the mid-section 420 can also have multiple tool containers 410 configured to store tools of various dimensions. In addition, one or more stationary cables 418 are availably affixed to the mid-section 420 and designed secure tools to the mid-section. The stationary cables 418 can be Velcro™ activated such that the cables 418 can be utilized to wrap around tools and thereby securing the tools to the mid-section 420. Alternatively, the mid-section 420 can include a plurality of tool containers 410 of various dimensions and at least one row of stationary straps 422 as illustrated in FIG. 15. In use, a tool can be positioned through a tool strap 422 and into a tool bag 410, thereby securing the tool within the tool bag 410.

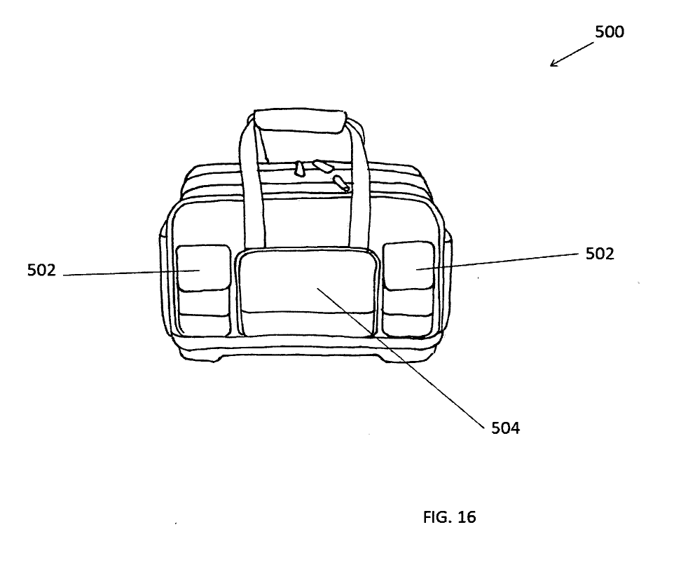

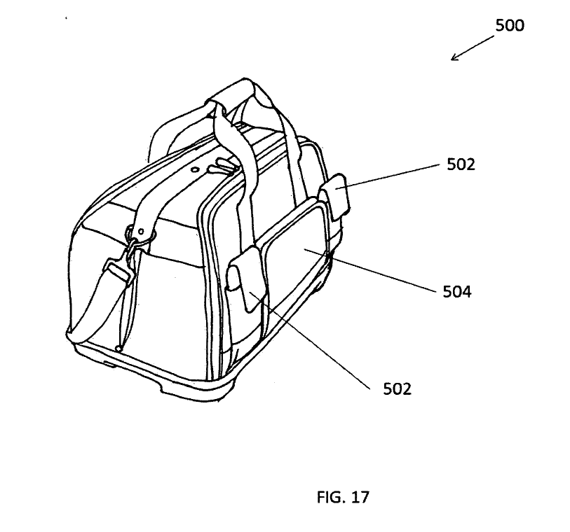

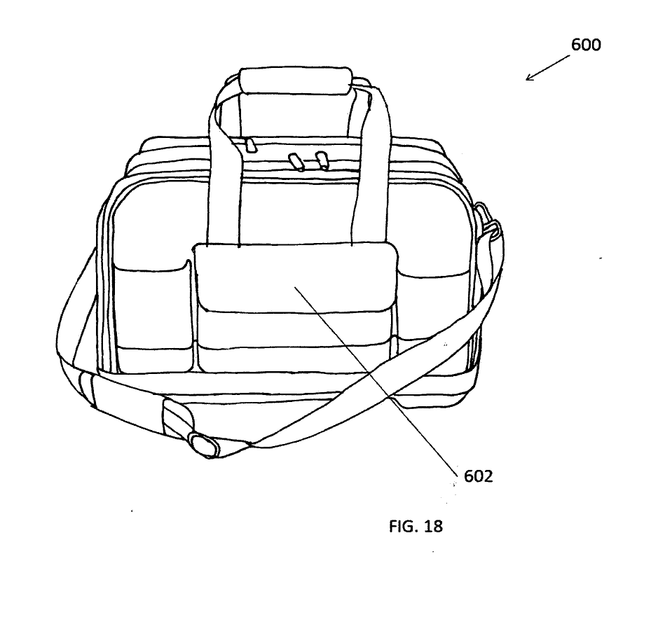

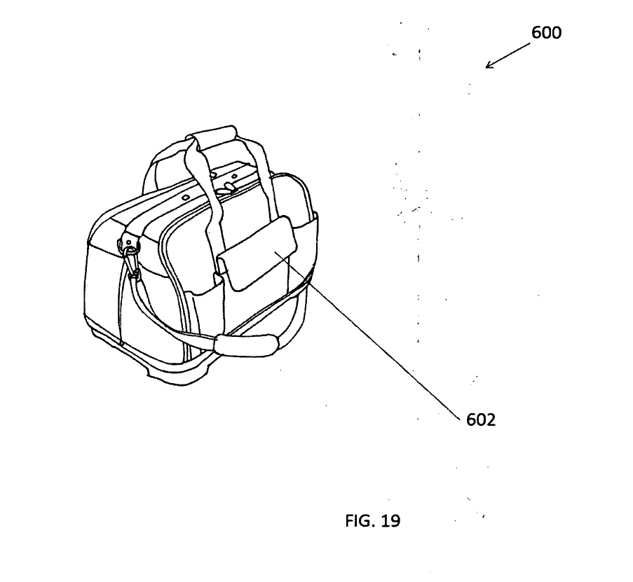

In another embodiment, a tool bag similar to the one described in FIG. 1 can have tool pockets with covers (instead of tool containers without covers) affixed to the front covers, as illustrated in FIG. 16. The tool pockets can either be covered with a folded down cover 502, or be enclosed using a zipper (not shown) 504. When closed, the tool pocket can effectively shield tools from outside environmental elements. FIG. 17 is a side view of the tool bag described in FIG. 16. As illustrated in FIG. 17, the tool bag 500 can include a larger tool pocket 504 positioned between two smaller two pockets 502. The larger tool pocket 504 in this case can be closed by a zipper (not shown) while the smaller tool pockets 502 are enclosed by folded down covers. Alternatively, a tool bag 600 can have one or more large tool pockets with folded down covers 602 as illustrated in FIGS. 18 and 19. The folded down cover allows a user easy access to tools stored in the large pockets 602. It should be appreciated that the different embodiments illustrated in FIGS. 12-19 are for exemplary purposes, as someone skilled in the art can easily rearrange for different types of tool pockets to better accommodate a user's particular needs.

What is claimed is:

1. A tool bag comprising:
a flat bottom surface connected to at least one side components, wherein the flat bottom surface includes a hard flat surface;
a mid-section including a hard surfaced compartment with two surfaces, the hard surfaced compartment positioned perpendicular to the flat bottom surface and divides the tool bag's internal bag space into two substantially equal portions;
a plurality of tool organizing apparatuses affixed to the two surfaces of the hard surfaced compartment configured to secure and organize tools.

2. The tool bag of claim 1 wherein the mid-section includes one or more reinforcement components positioned perpendicular to the bottom surface.

3. The tool bag of claim 1 wherein the tool bag further includes one or more front and back covers.

4. The tool bag of claim 3 wherein the front cover is configured to remain semi-open by one or more connective components.

5. The tool bag of claim 4 wherein the connective component includes one of a buckle, an elastic string, or a fabric cloth.

6. The tool bag of claim 3 wherein the front cover can be opened or closed via a zipper.

7. The tool bag of claim 3 further includes one or more handles connected to the front cover.

8. The tool bag of claim 7 further includes one or more anti-slippage component coupled to the one or more handles.

9. The tool bag of claim 1 further includes a U shaped handle and one or more wheels configured for easy pulling of the tool bag.
